(19) United States
(12) Patent Application Publication
(10) Pub. No.: US 2003/0198383 A1
(43) Pub. Date: Oct. 23, 2003

(54) Image data processing device and method thereof

(75) Inventors: Nobuyasu Yamaguchi, Kawasaki (JP); Tsugio Noda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/353,982

(22) Filed: Jan. 30, 2003

(30) Foreign Application Priority Data
Apr. 19, 2002 (JP) 2002-118243

(51) Int. Cl. G06K 9/18

(52) U.S. Cl. 382/183

(57) ABSTRACT

After a preprocess such as a process for extracting a portion of an image is performed by a preprocessing unit for an image such as a barcode, etc., which is obtained by an image data inputting unit within a first device such as a cellular phone equipped with a camera, etc., the image is transmitted to a second device such as an image processing server, etc. via a communications path by an image data transmitting unit. In the second device, an image process such as barcode data decoding, etc. is performed, and result data is notified to the first device via the communications path.

### BACKGROUND OF THE INVENTION

1. Field of the Invention

The present invention relates to an image data processing device having an image input device, and more particularly, to a portable device that can be used with an image input device such as a camera, or the like, and a communications path.

2. Description of the Related Art

In recent years, the use of the Internet by means of a cellular phone, a PDA (Personal Digital Assistant), etc. has been increasing, and a cellular phone, a PDA, etc., which are quipped with an image input device such as a camera, etc. have been developed.

To read coded data such as a barcode, a two-dimensional barcode, etc., a terminal called a dedicated barcode reader is used.

FIG. 1 exemplifies the configuration of a conventional image input processing device such as a barcode reader, etc.

An image input processing device 10 such as a barcode reader, etc. comprises: an image data inputting unit 11 reading abarcode image; an image data processing unit 12 receiving the read image from the image data inputting unit 11, and performing aprocess for the image data; and a process result outputting unit 13 receiving a process result from the image data processing unit 12.

After binarizing the read barcode image, the image data processing unit 12 performs area extraction to only take out the barcode portion. Then, the image data processing unit 12 extracts the data possessed by the barcode by decoding the barcode, and inputs the extracted data to the process result outputting unit 13 as coded data.

The barcode reader performs an image process and a decoding (extraction) process for the barcode data for the barcode image obtained with the camera, and finally outputs the coded data stored in the barcode. For these processes, an MPU the throughput of which is relatively high, or a dedicated LSI, and software which performs a process specific to a barcode image are required.

Additionally, Japanese Patent Laid-Open Publication No. 2001-103188 cuts down a terminal cost by arranging a decoding capability for barcode data on a server which is connected to a terminal via a communications line, and by transmitting a barcode image itself to the server to process the image.

As described above, in the conventional example, an image process and a barcode data decoding process are performed by the MPU and the memory of a device itself. Therefore, if an input image is a large screen image, and a complex image process is performed when barcode data is attempted to be captured with a terminal having a processor of low throughput like a portable terminal, processing time increases. As a result, more of the computing power of the MPU is required, or the processes themselves cannot be performed due to a limitation on a memory area. Additionally, since also the software which performs a process specific to a barcode image is installed in the device itself, hardware resources such as a memory for storing the software becomes necessary, leading to an increase in the device cost.

If a decoding process for barcode data is performed by a server as disclosed by Japanese Patent Laid-Open Publication No. 2001-103188, a barcode image is transmitted as such. Therefore, the amount of communication data is large, so that communication cost and time increase. Furthermore, a result of the barcode process is not transmitted to a terminal or other devices. Especially, on the side of a terminal directly used by a user, barcode data or its associated information cannot be used.

### SUMMARY OF THE INVENTION

An object of the present invention is to provide an image data processing device quickly performing complex image and information processes, even if the throughput (computing power or a memory space) of a device having an image input device is low, or software which performs a process specific to a barcode image, or the like is not installed.

Furthermore, the present invention provides an image data processing device and a method thereof, with which a terminal user or a third party can freely use barcode data from which a process result is obtained, and its associated information.

An image data processing device according to the present invention comprises: an image data inputting unit inputting an image including coded data; a preprocessing unit performing a preprocess for the image; an image data transmitting unit transmitting the image data for which the preprocess is performed to a server that performs an image process via a communications path; and a process result receiving unit receiving the data resultant from the image process performed by the server via the communications path.

An image data processing method comprises: an image data inputting step inputting an image including coded data; a preprocessing step performing a preprocess for the image; an image data transmitting step transmitting the image data for which the preprocess is performed to a server that performs an image process via a communications path; and a process result receiving step receiving the data resultant from the image process performed by the server via the communications path.

According to the present invention, after a preprocess is performed for an image, which is obtained by an image data processing device such as a cellular phone equipped with a camera, the image is transferred to a server that is connected via a communications path and performs an image process. Then, the server is made to perform the image process, and only a result of the image process is received by the image data processing device. Therefore, the amount of data becomes small at an image transfer, and the data can be quickly transferred. At the same time, a main process in the image process is performed by a server the throughput of which is high. Therefore, a result obtained by performing a desired data process can be quickly obtained even if the computing power or the memory space of the image data processing device is insufficient.

### BRIEF DESCRIPTION OF THE DRAWINGS

FIG. 1 exemplifies the configuration of a conventional image input processing device such as a barcode reader;

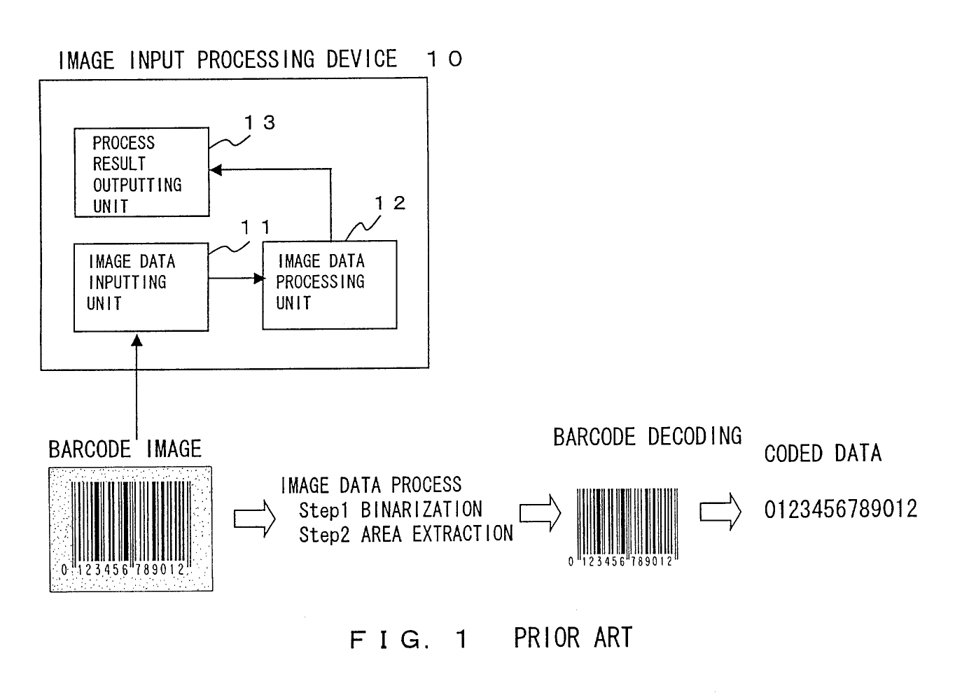

FIG. 2 shows a first preferred embodiment according to the present invention;

FIG. 3 shows the outline of processes performed by devices in the first preferred embodiment according to the present invention;

FIG. 4 shows a second preferred embodiment according to the present invention;

FIG. 5 shows the outline of processes performed by devices in the second preferred embodiment according to the present invention;

FIG. 6 shows a third preferred embodiment;

FIG. 7 shows the outline of processes performed by devices in the third preferred embodiment according to the present invention;

FIG. 8 shows a fourth preferred embodiment according to the present invention;

FIG. 9 shows the outline of processes performed by devices in the fourth preferred embodiment according to the present invention;

FIG. 10 shows a fifth preferred embodiment according to the present invention; and

FIG. 11 shows the outline of processes performed by devices in the fifth preferred embodiment according to the present invention.

### DESCRIPTION OF THE PREFERRED EMBODIMENTS

An image data processing device according to a preferred embodiment of the present invention is configured by: a first device having an information inputting unit inputting image information including coded data, a data transferring unit transferring the input data, and a process result receiving unit receiving a process result from a second device; and the second device having a data receiving unit receiving data, a data processing unit performing a process for the data, and a process result transmitting unit transmitting a result of the data processing unit to the first device. The first and the second devices are connected by a communications path, and mutually transmit/receive data.

Or, the image data processing device is configured by: a first device having an information inputting unit inputting image information including coded data, a data transferring unit transferring input data, and a process result receiving unit receiving a process result from a second device; and a second device having a data receiving unit receiving data, a data processing unit performing a process for the data, and a process result transmitting unit transmitting a result of the data processing unit to the first device. The first and the second devices are connected by a communications path, and mutually transmit/receive information. At the same time, information according to a result of the image processing unit within the second device is transmitted/received to/from a third device connected by a communications path.

Or, the image data processing device is configured by: a first device having an information inputting unit inputting image information including coded data, a data transferring unit transferring input data, and a process result receiving unit receiving a process result from a second device; and a second device having a data receiving unit receiving data, a data processing unit performing a process for the data, and a process result transmitting unit transmitting a result of the data processing unit to the first device. The first and the second devices are connected by a communications path, and mutually transmit/receive information.

The outline of the preferred embodiment according to the present invention is explained below.

First of all, a method applied in the case where an image whose data amount is large is obtained by a device (the first device) whose data throughput is relatively low, such as a camera, etc. is described.

Firstly, a barcode is input by the camera (the first device), an image process and barcode decoding are performed by a second device (an image processing server (a data processing device whose data throughput is high, and can transmit/receive data to/from the camera (the first device) via a communications path)), and information corresponding to the coded data stored in the barcode is received by the camera (the first device).

Image data is transmitted from the first device (the camera, a cellular phone, etc.) equipped with an image input device, whose available memory is limited, to the second processing device which is connected by a communications path and has a large memory, and a process result is obtained. In this way, an image process which requires a large memory can be performed even if the first device equipped with the image input device can be used with-only a small memory.

Conventionally, in the first device such as a camera, a cellular phone, etc., a barcode image process and a barcode decoding process are performed in a barcode image process, and coded data stored in a barcode is extracted. A software library of 100 KB or more is required respectively for the barcode image process and the barcode decoding process. If a grayscale image of a CIF (Common Intermediate Format) size (352 by 288 pixels) is used as a barcode image, only this image requires 100-KB of memory.

The case where a cellular phone equipped with a camera is assumed to be used for a barcode process is considered. For the cellular phone, its computing power and memory area are mainly used for the transmission/reception of a telephone call, and a telephone book capability for telephone numbers. For an image input and an image process, an empty space is used, and the amount of available memory is limited to several hundred KB. Accordingly, an image process which requires a large memory, such as a barcode process, cannot be performed by the cellular phone alone.

In the meantime, an image server connected by a communications line can perform abarcode process, since it can be used with a high processing speed and a memory required for the process. Additionally, a software library of a barcode image process, a barcode decoding process, etc. is installed on the image server, thereby eliminating the need for storing the software library in the memory of the cellular phone.

Accordingly, data is transmitted/received between the cellular phone equipped with the camera and the image processing server via a communications line, whereby the image process which requires a large memory can be implemented.

The shortening of a communication time between the first and the second devices is described next.

A barcode is input by the first device such as a camera, etc., an image process and barcode decoding are performed by the second device (image processing server), and coded data stored in the barcode is extracted and transmitted as such to the third device. If the first device equipped with an image input device transmits image data to the second processing device, and issues a request to perform a process to the third device connected by a communications path according to a process result, the process result of the second device is directly transmitted from the second device to the third device instead of transmitting the process result of the second device to the first device, which then issues the request to perform the process to the third device. As a result, a communication means can be simplified and made faster.

If shooting is made by a cellular phone equipped with a camera, the speeds of the communications paths between the first and the second devices, and between the first and the third devices are up to 1.2 KB/s (9600 bps: the communication speed of the cellular phone), whereas the communication speed of the second and the third devices, which are connected by the Internet, is 180 KB/s (1.5 Mbps: the communication speed of the third terminal (PC) connected to the Internet. ADSL in this case). A big difference exists between the communication speeds.

If coded data is returned from the second device to the first device, it must be retransmitted from the first device to the third device that performs a database process so as to extract corresponding information. At this time, supplementary data such as the network address of the third device, etc., which must be obtained from the second device, exist, and a communication amount on a low-speed communications path increases.

Accordingly, the coded data and the network address of the first device are directly transferred from the second device to the third device, corresponding information is prepared, and a process result is returned to the first device, so that an excess communication amount can be reduced.

Measures to speed up a communication process by performing a preprocess in a terminal is described below.

If a barcode is input by a camera, etc. (the first device), and a barcode image process and a barcode decoding process are performed by the second device (image processing server), grayscale image data input by the first device is transferred to the second device, by which the barcode image process and the barcode data decoding process are performed to extract coded data stored in the barcode. Here, in a preprocess within the barcode image process of the second device, an image binarization process whose processing load is light is performed by the first device, and not the grayscale image data but the binarized image data is transferred to the second device.

Part of the barcode image process that the second device is requested to perform is performed on the side of the first device equipped with an image input device, whereby the load on the second processing device ca be lightened, a transfer data size can be reduced, and a communication processing time can be shortened.

An image binarization process is approximately 5 percent of the whole of the barcode image process and the barcode decoding process. Process requests reach the server simultaneously from a plurality of first devices. In the case of a server that can simultaneously process requests from 20 first devices, the image binarization process is performed by the first devices beforehand, so that the server can simultaneously process the requests from the 20 first devices or more, leading to an increase in the speed of the server process. Additionally, the binarization process is performed by the first device, whereby a transfer image data size can be reduced to approximately ⅛ from 100 KB to 12 KB. If the communications path between the first and the second devices has a transmission speed of 1.2 KB/s (9600 bps), the transmission/reception time of 80 seconds is reduced to 10 seconds, which is ⅛, for grayscale image data. That is, 8-times high-speed transfer can be implemented.

Furthermore, measures to speed up a communication by performing a partial extraction process in a first terminal (the first device) is described below.

If a barcode is input by a camera, etc. (the first device), and a barcode image process and a barcode decoding process are performed by the second device (image processing server), grayscale image data input by the first device is transferred to the second device, by which the barcode image process and the barcode decoding process are performed to extract coded data stored in the barcode. Here, a process for extracting a portion from the barcode image data is performed by the first device, and the extracted portion is transferred to the second device.

As a result, a transfer data size can be reduced, and a communication processing time can be shortened.

In case of a barcode, especially, a one-dimensional barcode, a decoding process can be performed if there is at least data obtained by extracting a barcode symbol portion by one horizontal line. A portion of 352 by 1 pixels, which corresponds to the one horizontal line of the barcode symbol portion, is extracted from monochrome image data of the CIF (352 by 288 pixels) size, and transferred, so that a transfer image data size can be reduced to 1/288 from 100 KB to 0.3 KB of the grayscale image data. However, decoding is unsuccessfully performed in some cases only with such an extracted portion. At this time, an instruction to extract and transmit another portion is issued from the second device to the first device. If decoding is successfully performed even after a transmission is repeated by n (1<n<288) times, a transfer image data size can be reduced to n/288. Additionally, instead of extracting another portion, a threshold value for the binarization process, which is performed by the first device, may be changed, and binarized image data may be transmitted to the second device.

Furthermore, measures to speed up a communication by performing an image compression process in a terminal is explained.

BMP compression (Japanese Patent Laid-Open Publication No. Hei 8-51545) is performed for data transmitted between the first device equipped with an image input device, and the second device that performs an image process, whereby transmission data can be reduced, and a communication time can be shortened.

The BMP compression is a bitmap data compression method (for further details, refer to Japanese Patent Laid-Open Publication No. Hei 8-51545), which can implement efficient data compression with a simple algorithm without requiring special hardware at a bitmap data transfer. For example, monochrome binary image data of the CIF size can be compressed to approximately 1/50 or smaller. Additionally, a compression/decompression process can be quickly performed in approximately 0.2 seconds. If the transmission speed of the communications path between the first and the second devices is 1.2 KB/s (9600 bps), transmission/reception time of 10 seconds in the case where an image is not compressed is reduced to 1/50 in the case where the image is compressed. Therefore, this 0.2 seconds plus the compression/decompression process time of 0.2 seconds is 0.4 seconds in total, which can implement 25-times speed-up.

A specific explanation is provided below with reference to the drawings.

In preferred embodiments, a process for a monochrome image is explained. For a color image, its monochrome image can be simply obtained if only luminance information is extracted from color information of a pixel. Therefore, the following preferred embodiments are applicable also to a color image.

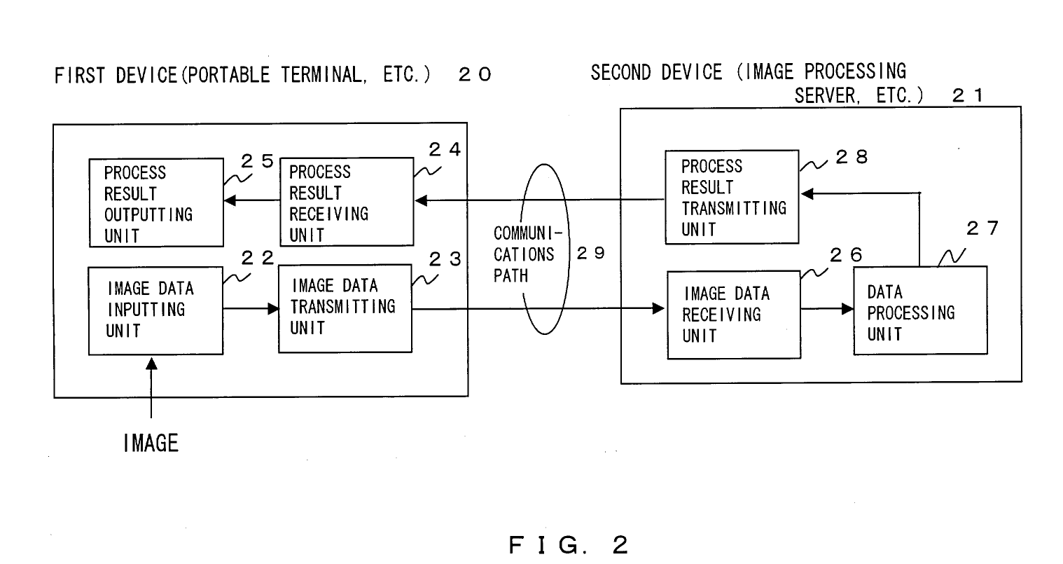

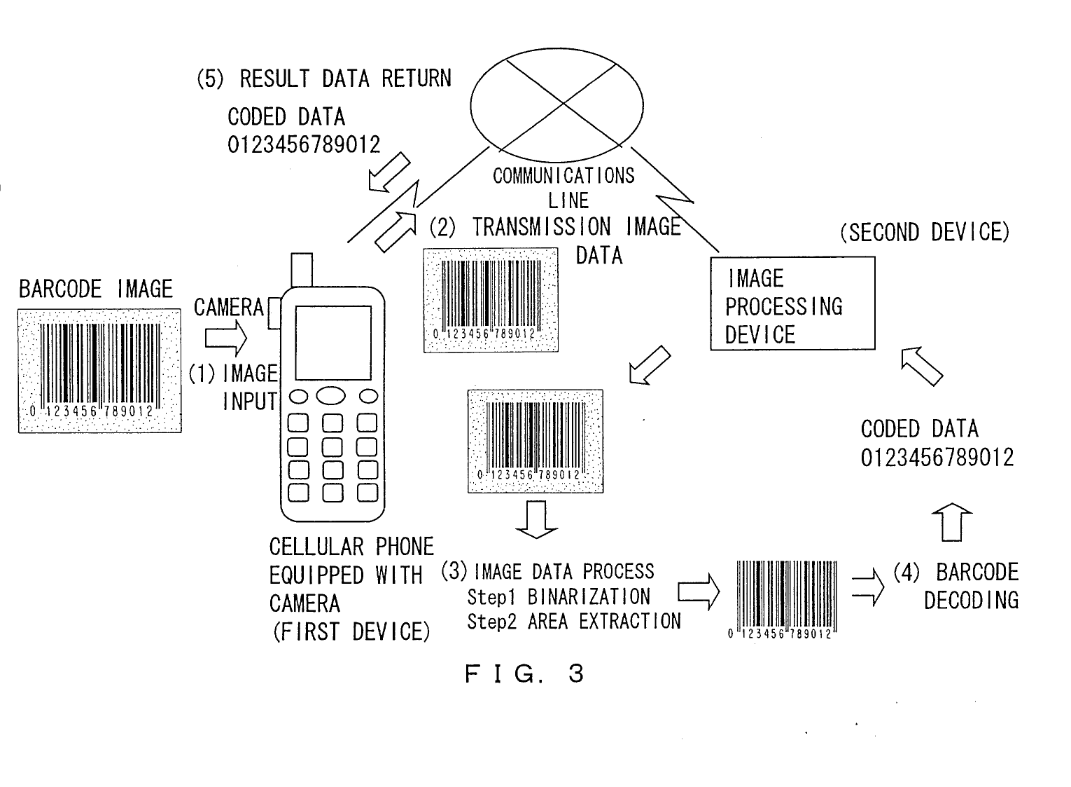

FIG. 2 shows a first preferred embodiment according to the present invention, whereas FIG. 3 shows the outline of processes performed by devices.

In FIG. 2, a first device 20 such as a portable terminal equipped with an image input capability obtains image data. This obtainment is made by an image data inputting unit 22. The image data obtained by the image data inputting unit 22 is transmitted to an image data transmitting unit 23, and further transmitted to a second device 21 such as an image processing server, etc. via a communications path 29. The image data from the first device 20 is received by an image data receiving unit 26 within the second device 21, and the received image data is transmitted to a data processing unit 27. In the data processing unit 27, a barcode decoding process, etc., is performed. A result of the data process performed by the data processing unit 27 is transmitted to a process result transmitting unit 28, and further transmitted to the first device 20 via the communications path 29. In the first device 20, the transmitted process result is received by a process result receiving unit 24, passed to a process result outputting unit 25, and presented to a user of the first device 20 on a display (not shown).

Namely, image data input from the image data inputting unit such as a CMOS, a CCD sensor, etc., which is equipped by the first device, is transmitted to the second device connected by a communications path via the data transmitting unit. The image data received by the second device is held by the image data receiving unit. An image process, which is prespecified by the data processing unit (here, the barcode image process and the barcode decoding process), is performed for the held image data, and its result is transmitted to the process result transmitting unit. The result data is further transmitted to the first device via the communications path, and input to the process result outputting unit within the first device. In the first device, an image process result (coded data) can be obtained without performing an actual image process.

The flow of data is described more specifically with reference to FIG. 3. If a barcode is input as an image by a camera equipped by a cellular phone ((1)), this does not has any sense as it is. A process (decoding process) for converting the barcode image into coded data such as a numeral, a character, etc. embedded in the barcode, and for extracting the coded data from the barcode is required. Therefore, the image data is transmitted to the second device ((2)), and an image process and a decoding process, which are intended to convert the image data into coded data such as a numeral, a character, etc., are performed ((3) and (4)). In this preferred embodiment, the image process and the decoding process are performed by the second device (image processing server) connected by a communications path. In the second device (image processing server), an image process such as a binarization process, a barcode area extraction process, etc. is performed for the received image data, and then, the decoding process is performed. Coded data resultant from the decoding process is returned to the transmission source ((5)). In the first device, the coded data returned from the second device (image processing server) is displayed on a screen, so that the contents of the barcode can be displayed. For a barcode, its coded data itself does not have a sense, and information that is stored in a database, etc. and corresponded to the coded data is more important and has a sense in many cases. Therefore, the information may be converted by the second device (image processing server), and the information corresponded to the coded data may be returned to the first device.

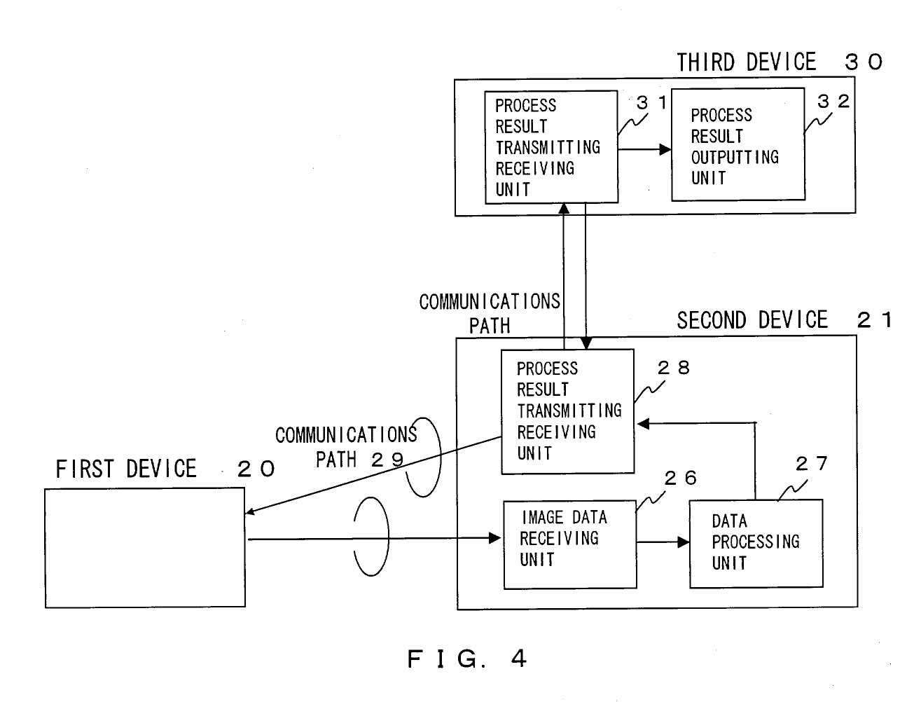

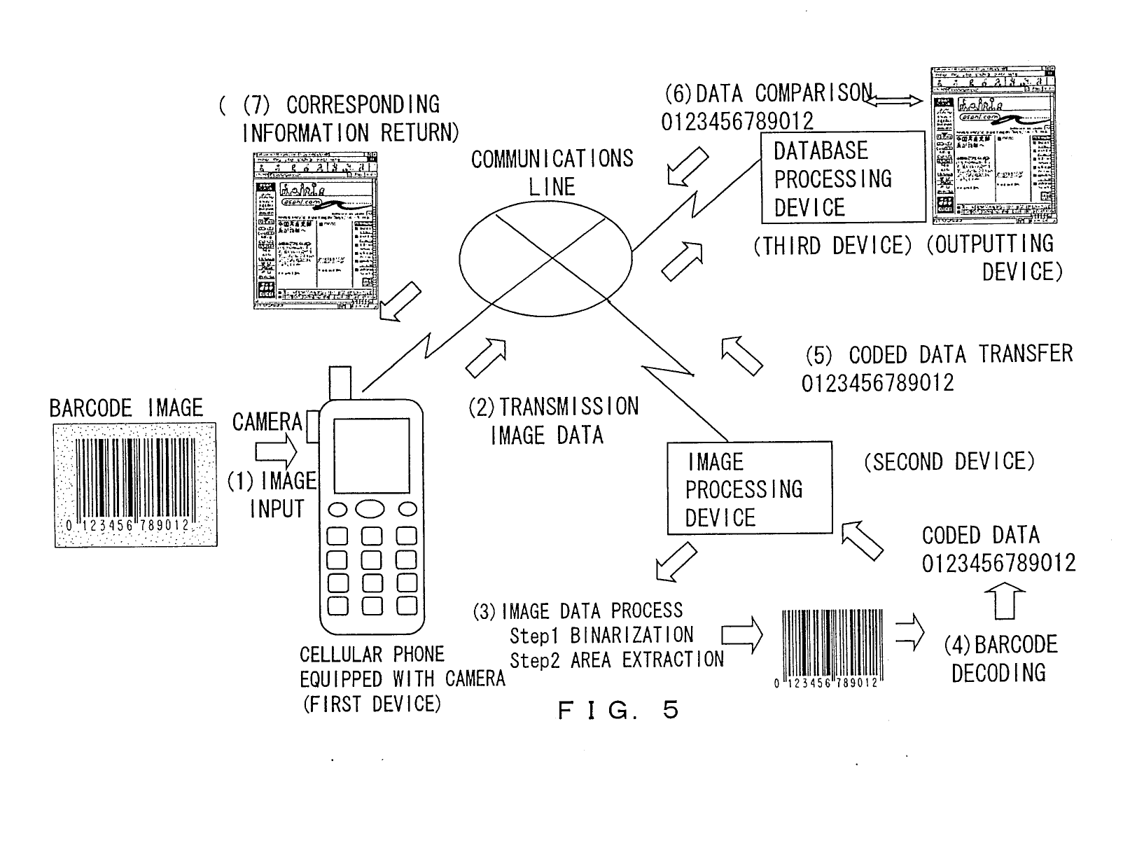

FIG. 4 shows a second preferred embodiment according to the present invention, whereas FIG. 5 shows the outline of processes performed by devices.

As shown in FIG. 4, if a first device 20 equipped with an image input device transmits image data to a second device 21, and issues a request to perform a process to a third device 30 connected by a communications path according to a process result, the process result of the second device 21 is directly transmitted to the third device 30 instead of issuing the request from the first device 20 to the third device 30. As a result, a communication means from the second device 21 to the first device 20 is simplified and made faster.

As shown in FIG. 5, a barcode image is input by the first device ((1)), barcode decoding is performed by the second device (image processing server) ((3) and (4)), and coded data is transmitted to the third device, which is a database processing device ((5)). Then, information corresponding to the coded data is extracted by the third device ((6)). If an output device such as a monitor, etc. is comprised by the third device, the information corresponding to the coded data can be verified on its screen. Or, if this information is verified by the first device, it is directly transmitted from the third device to the first device ((7)).

As described above, it achieves a simpler communication than the first embodiment in which only an image process (barcode decoding) is performed and the returned code data is returned to the third device again.

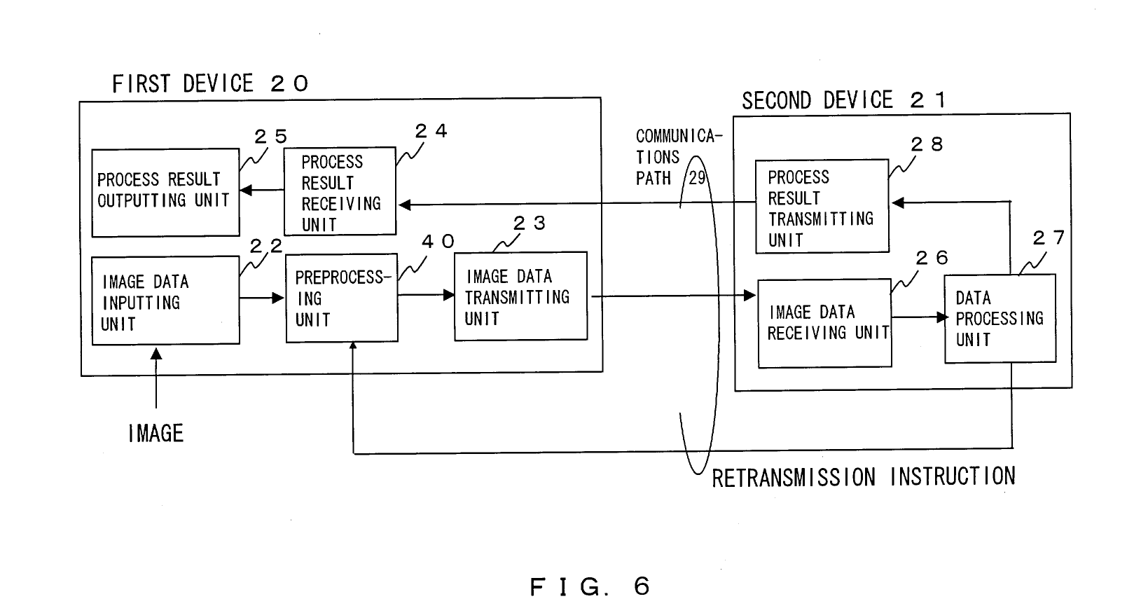

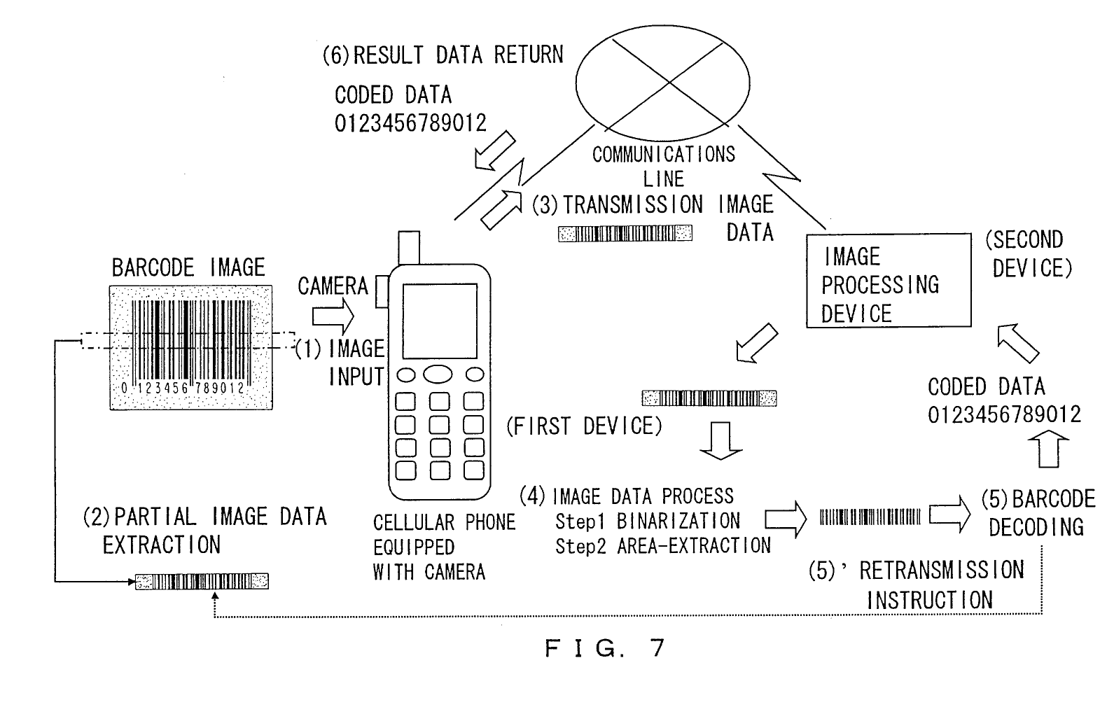

FIG. 6 shows a third preferred embodiment according to the present invention, whereas FIG. 7 shows the outline of processes performed by devices.

In FIG. 6, the same constituent elements as those shown in FIG. 2 are denoted with the same reference numerals, and their explanations are omitted.

Within a first device 20, a preprocessing unit 40, which performs a preprocess in an image process performed for image data, is arranged between an image data inputting unit 22 and an image data transmitting unit 23. In the preprocessing unit 40, for example, a process for extracting a portion from image data is performed, and the extracted portion is transferred to a second device 21. As a result, a transfer data size can be reduced, and a communication processing time can be shortened. Or, binarization may be performed as the preprocess. If a data processing unit 27 within the second device 21 fails to process the image data transmitted from the first device 20, it issues a request to extract and retransmit another portion to the preprocessing unit 40 within the first device 20 via a communications path (in the case where the process for extracting a portion from image data is performed as the preprocess). Or, in the case where binarization is performed as the preprocess, the data processing unit 27 within the second device 21 issues a request to retransmit a new binary image, which is obtained by changing a threshold value used for the binarization to a different value, to the preprocessing unit 40 within the first device 20 if it fails to process the image data.

Assume that barcode image data is input by the first device ((1)), and the process for extracting a portion from the barcode image data is performed as a preprocess ((2)) as shown in FIG. 7. In this case, the extracted barcode image data is transferred to the second device (image processing device) ((3)), by which an image process and a barcode decoding process are performed ((4) and (5)). If the barcode decoding process is unsuccessfully performed, an instruction to extract and retransmit another portion of the image data is issued from the second device (image processing device) to the first device (cellular phone equipped with a camera ((5′)). When the barcode decoding process is successfully performed, resultant coded data is returned to the cellular phone equipped with the camera ((6)).

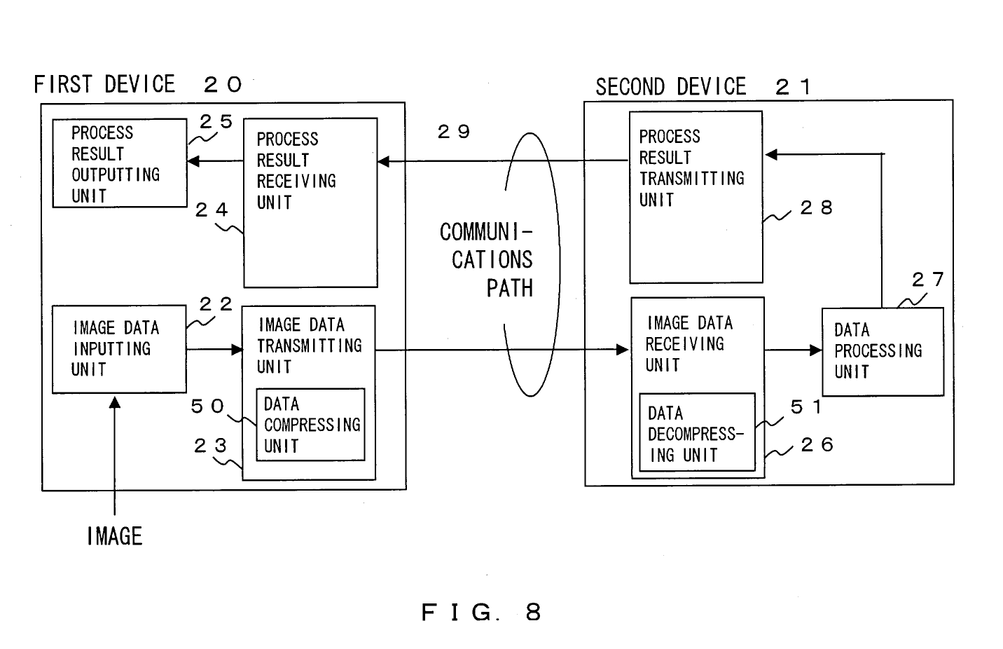

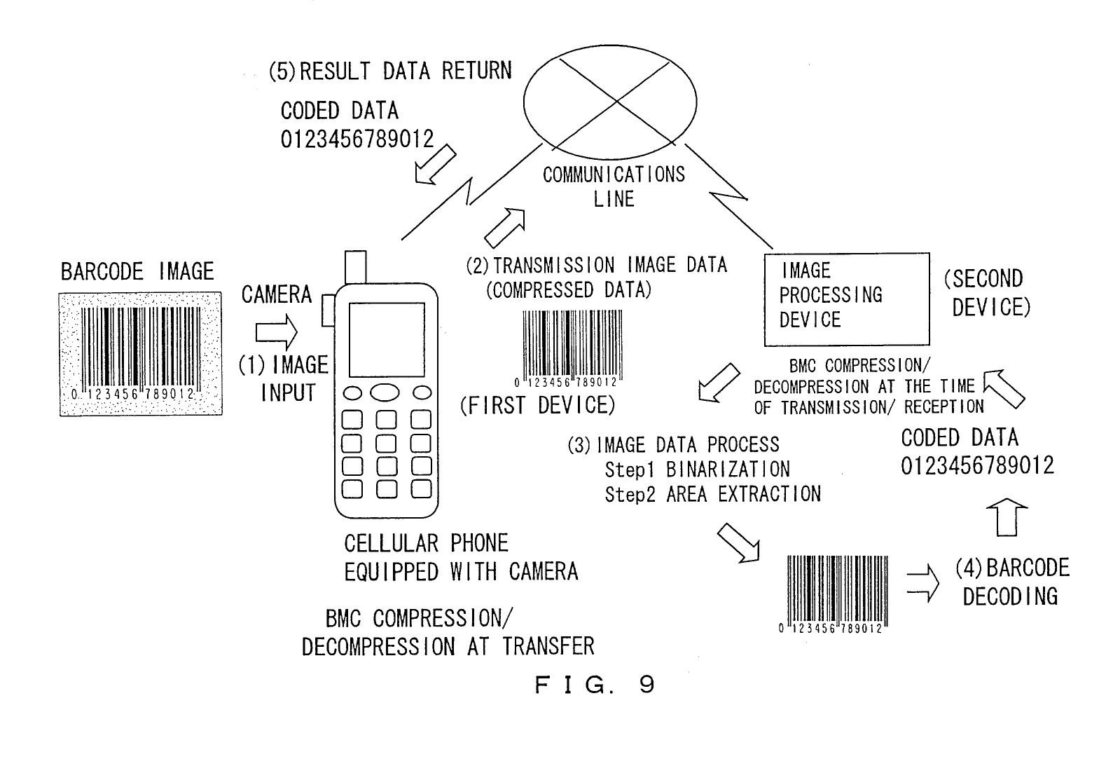

FIG. 8 shows a fourth preferred embodiment according to the present invention, whereas FIG. 9 shows the outline of processes performed by devices.

In FIG. 8, the same constituent elements as those shown in FIG. 6 are denoted with the same reference numerals, and their explanations are omitted.

As shown in FIG. 8, a data compressing unit 50 and a data decompressing unit 51, which are intended to compress and decompress transmission data in a data transmission made by a communications path 29 that connects a first device 20 and a second device 21, are arranged, whereby the amount of transmission data is reduced, and a communication time is shortened.

As shown in FIG. 9, a BMC coding method is used as an image data compression process in order to shorten an image data transmission time for an image process and a barcode decoding process, and image data to be transmitted/received is compressed, thereby shortening the transmission/reception time between the devices.

That is, in a cellular phone equipped with a camera (the first device), a barcode image is captured ((1)), and the input image is compressed by the BMC compression/decompression capability of the cellular phone equipped with the camera. Then, the compressed image data is transmitted to the second device (image processing device) via a communications line ((2)). In the image processing device, upon receipt of the compressed image, the image is decompressed, and an image data process is performed ((3)). In FIG. 9, binarization and area extraction are performed as the image process. However, these processes maybe performed on the side of the first device. The barcode of the barcode image for which the image process is performed is decoded ((4)), coded data is extracted, and the extracted coded data is transmitted to the cellular phone equipped with the camera as data resultant from the image process ((5)).

An example where image binarization is performed as a preprocess, especially, an example where a two-dimensional barcode is handled is described below.

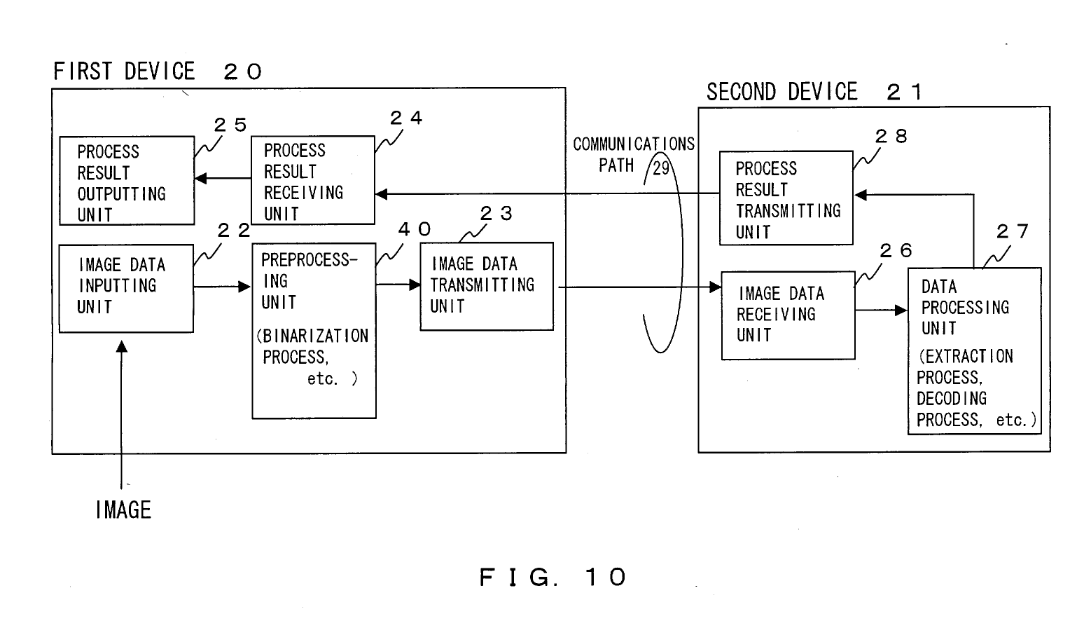

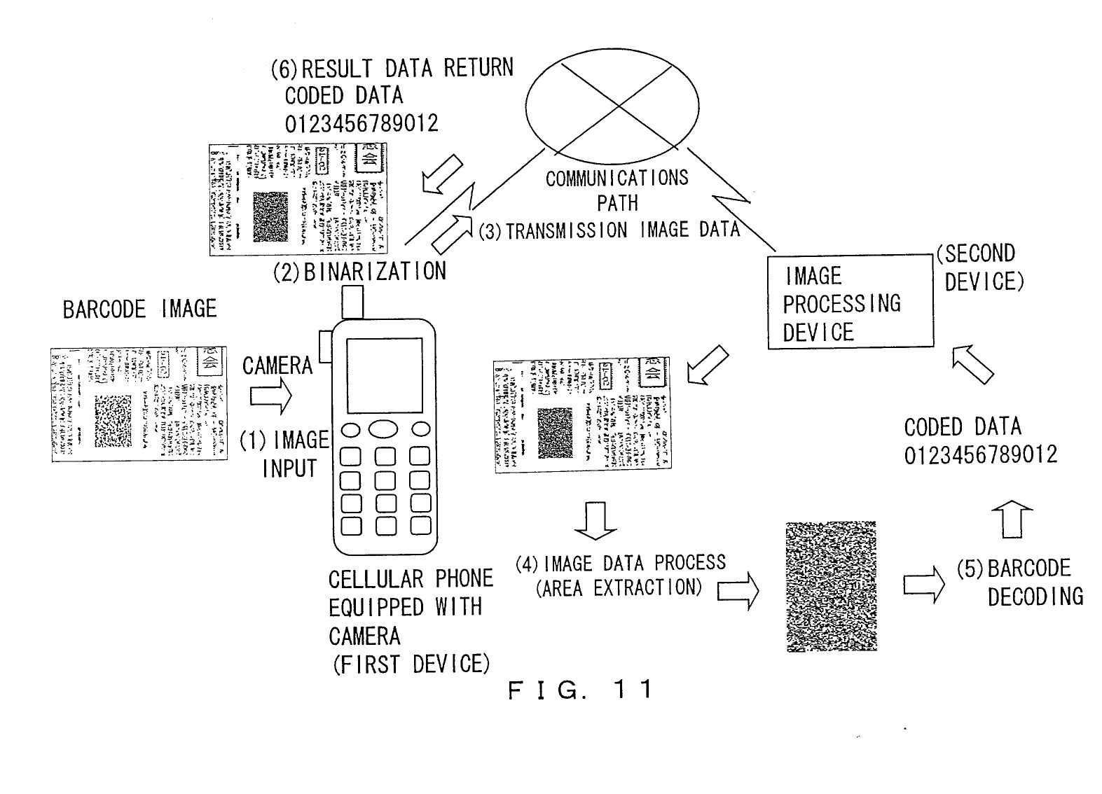

FIG. 10 shows a fifth preferred embodiment according to the present invention, whereas FIG. 11 shows the outline of processes performed by devices.

As coded data handled by the present invention, a one-dimensional barcode, a two-dimensional barcode, or data according to the one-dimensional or the two-dimensional barcode is assumed. This preferred embodiment refers to an example where a two-dimensional barcode is used. As a matter of course, the present invention is also applicable to a one-dimensional barcode in a similar manner.

In FIG. 10, the same constituent elements as those shown in FIG. 6 are denoted with the same reference numerals, and their explanations are omitted.

Within a first device 20, a preprocessing unit 40, which performs a preprocess in an image process performed for image data, is arranged between an image data inputting unit 22 and an image data transmitting unit 23. A color or a grayscale image obtained by reading an original including a two-dimensional barcode is input from the image data inputting unit 22. In the preprocessing unit 40, a binarization process for reducing gray levels of image data is performed. As a binarization process technique, a technique using the characteristic of a two-dimensional barcode as disclosed by Japanese Patent Laid-Open Publication No. 2001-251507 is used, so that the accuracy of a later decoding process, etc., can be improved. Additionally, by performing the binarization process, the size of image data is reduced to 1/24 (in the case where an original image is color). As a result, a transfer data size can be reduced, a communication processing time can be shortened, and a communication cost can be cut down.

The image data that is binarized and transferred to the second device 21 is transmitted to an image processing unit 27 within the second device 21, by which an image process and a barcode decoding process are performed. As an image process, a process for extracting a two-dimensional barcode area, or the like is performed. The technique using the characteristic of a two-dimensional barcode as disclosed by Japanese Patent Laid-Open Publication No. 2001-307014 is used also here, whereby a two-dimensional barcode area can be extracted more securely, and also the accuracy of barcode decoding is improved.

Note that the process for extracting a two-dimensional barcode area may be performed by a preprocessing unit 40 within the first device 20 as a preprocess. In this case, a transfer data size is further reduced, so that a communication processing time can be shortened, and a communication cost can be cut down. However, the algorithm of the process for extracting a two-dimensional barcode area is complex. Therefore, if the throughput of the first device 20 is much lower than that of the second device 21, an excess processing time is required, and can possibly exceed a shortened communication processing time. Accordingly, a process handled as the preprocess is suitably selected in consideration of the throughputs of the first device 20 and the second device 21.

In FIG. 11, an image including a two-dimensional barcode is obtained from a cellular phone equipped with a camera, which is the first device ((1)). Then, a preprocess such as binarization of the obtained image, or the like is performed ((2)), and the image data is transmitted to an image processing device, which is the second device, via a communications line ((3)). In the image processing device, an image data process such as area extraction from the received image, or the like is performed ((4)), the two-dimensional barcode is decoded and converted into coded data ((5)), and the coded data resultant from the image process is returned to the cellular phone equipped with the camera via the communications line ((6)).

As described above, according to the present invention, input image data including coded data of a device having an image input device is transmitted to an image processing server, and a process result is obtained, whereby it becomes possible to provide an image data processing device, which quickly performs a process of an image including complex coded data and its information process, even if the throughput of the device having the image input device is low.

What is claimed is:

1. An image data processing device, comprising:
an image data inputting unit inputting an image including coded data;
a preprocessing unit performing a preprocess for the image;
an image data transmitting unit transmitting the image data for which the preprocess is performed to a server that performs an image process via a communications path; and
a process result receiving unit receiving data resultant from the image process performed by the server via the communications path.

2. The image data processing device according to claim 1, wherein
the preprocess is binarization of an image.

3. The image data processing device according to claim 1, wherein
the preprocess is a process for extracting a portion of an image.

4. The image data processing device according to claim 1, wherein
an image compression process is performed as the preprocess.

5. The image data processing device according to claim 1, wherein
the server is configured by a plurality of image processing devices, one of which performs part of a process for image data transmitted from the image data processing device, the other image processing devices share and perform a remainder of the process, and an obtained result is returned to the image data processing device.

6. The image data processing device according to claim 1, wherein
the server makes the image data processing device retransmit the image for which the preprocess is performed under a different condition, if the server fails to perform an image process for the image which is transmitted from the image data processing device, and the preprocess is performed for.

7. The image data processing device according to claim 6, wherein
the different condition indicates that a threshold value for binarization is changed to a different value, if the binarization is performed as the preprocess.

8. The image data processing device according to claim 6, wherein
the different condition is to extract a different portion of an image if image extraction is performed as the preprocess.

9. The image data processing device according to claim 1, wherein
the image including the coded data is an image including an image of a barcode.

10. The image data processing device according to claim 9, wherein
the barcode is a two-dimensional barcode.

11. An image data processing method of an image data processing device, comprising:
inputting an image including coded data;
performing a preprocess for the image;
transmitting image data for which the preprocess is performed to a server that performs an image process via a communications path; and
receiving data resultant from the image process performed by the server via the communications path.

12. The image data processing method according to claim 11, wherein
the preprocess is binarization of an image.

13. The image data processing method according to claim 11, wherein
the preprocess is a process for extracting a portion of an image.

14. The image data processing method according to claim 11, wherein
an image compression process is performed as the preprocess.

15. The image data processing method according to claim 11, wherein
the server is configured by a plurality of image processing devices, one of which performs part of a process for image data transmitted from an image data processing device, the other image processing devices share and perform a remainder of the process, and an obtained result is returned to the image data processing device.

16. The image data processing method according to claim 11, wherein
if the server fails to process the image transmitted from said image data transmitting, for which the preprocess is performed, the server makes the image, for which the preprocess is performed under a different condition, retransmitted.

17. The image data processing method according to claim 16, wherein
the different condition indicates that a threshold value for binarization is changed to a different value, if the binarization is performed as the preprocess.

18. The image data processing method according to claim 16, wherein
the different condition is to extract a different portion of an image if image extraction is performed as the preprocess.

19. The image data processing method according to claim 11, wherein
the image including the coded data is an image including an image of a barcode.

20. The image data processing method according to claim 19, wherein
the barcode is a two-dimensional barcode.
